(19) United States
(12) Patent Application Publication
(10) Pub. No.: US 2006/0259464 A1
(43) Pub. Date: Nov. 16, 2006

(54) Selection of audio categories and files in entertainment system

(76) Inventors: Francis E. Szczublewski, Macomb, MI (US); Laci J. Jalics, Ray, MI (US); Keenan A. Estese, Kokomo, IN (US)

Correspondence Address: DELPHI TECHNOLOGIES, INC., M/C 480-410-202, PO BOX 5052, TROY, MI, 48007, US

(21) Appl. No.: 11/125,975

(22) Filed: May 10, 2005

(51) Int. Cl. G06F 17/30

(52) U.S. Cl. 707/3

(57) ABSTRACT

An entertainment system uses a user interface with existing head unit controls, such as radio preset controls and tuner controls, to select an audio file is selected for playback. In particular, a user can access audio files using the preset controls to access associated metadata, such as artist, album, and genre information.

### TECHNICAL BACKGROUND

The present invention relates generally to entertainment systems. More particularly, the present invention relates to mobile entertainment systems.

### BACKGROUND OF THE INVENTION

The vast majority of vehicles currently in use incorporate vehicle entertainment systems for entertaining drivers and passengers during their travels. For example, vehicle audio systems provide information and musical programming to many motorists daily. These audio systems typically include an AM/FM radio receiver that receives radio frequency (RF) signals. These RF signals are then processed and rendered as audio output.

In addition to a radio receiver, vehicle audio systems often incorporate some functionality for playing prerecorded music. For example, some vehicle audio systems incorporate cassette or compact disk (CD) players. An increasing number of vehicle audio systems also incorporate functionality for playing audio files stored in any of a variety of formats, including, for example, the MP3, MP3Pro, WMA, AAC, and Ogg-Vorbis formats. These digitally compressed formats allow storage media, such as CDs, to store many more songs relative to uncompressed formats, such as the CD Audio format. For example, with a compression of 10:1, it is possible to store well over 100 songs on a single CD or thousands of songs on a hard disk drive (HDD), depending on disk capacity.

In addition, the compressed data contains metadata information about the aural component in an ID3 tag. This metadata may include, for example, the song title, artist, album, and genre. Using this metadata provides an easy filter mechanism for the user to select criteria for browsing a song list or library.

Many conventional in-vehicle compressed audio players have a limited capability for filtering and sorting songs based on metadata field criteria. Many such players can also read playlists that are generated by popular MP3 software, including MusicMatch. Playlists contain pointers to selected songs within a song list or library. One limitation associated with these players, however, is that selecting a metadata field (e.g., artist name) or a playlist requires at least one additional step. Generally, this additional step involves scrolling through a menu list of metadata fields or playlists. This process is both time-consuming and visually intensive. For in-vehicle human-machine interfaces, task completion times and head-down time should be minimized so that the driver is not distracted from his or her primary task, i.e., driving.

### SUMMARY OF THE INVENTION

According to various example embodiments of the present invention, an audio file is selected for playback via an entertainment system using a user interface with existing head unit controls, such as radio presets and tuner controls. In particular, audio files are accessed using associated metadata, such as artist, album, and genre information.

One embodiment of the invention is directed to a method to select an audio file that is associated with metadata fields for output via an entertainment system having preset controls. A preset control is associated with a metadata field. When a preset control is actuated, a set of filter criteria related to the metadata field associated with the actuated preset control is presented. A user selection of one of the presented filter criteria is received. A set of file identifiers associated with the selected filter criterion is presented. A user selection of one of the file identifiers is received. The selected file identifier identifies an audio file for output via the entertainment system. This method may be embodied in processor-readable media.

In another embodiment, an entertainment subsystem includes a media subsystem configured to retrieve data from a data storage medium storing audio files that are each associated with metadata fields. A user interface subsystem has preset controls. A microprocessor operatively coupled to the media subsystem and the user interface subsystem is configured to associate a preset control with a metadata field. When a preset control is actuated, the microprocessor commands the user interface subsystem to display a set of filter criteria related to the metadata field associated with the actuated preset control. The microprocessor receives a user selection of one of the presented filter criteria via the user interface subsystem and commands the user interface subsystem to display a set of file identifiers associated with the selected filter criterion. The microprocessor receives a user selection of one of the file identifiers via the user interface subsystem. The selected file identifier identifies a particular one of the audio files. A speaker arrangement operatively coupled to the microprocessor is configured to output the audio file identified by the selected file identifier.

Various embodiments may provide certain advantages. For instance, various embodiments may facilitate navigation and playback of a large number of audio files for vehicle entertainment systems using an intuitive user interface. As a result, driver interaction with the user interface and the resulting potential for driver distraction may be reduced.

Additional objects, advantages, and features of the present invention will become apparent from the following description and the claims that follow, considered in conjunction with the accompanying drawings.

### BRIEF DESCRIPTION OF THE DRAWINGS

FIG. 1 is a block diagram illustrating an example vehicle entertainment system.

FIG. 2 illustrates an example user interface for the vehicle entertainment system of FIG. 1.

FIG. 3 illustrates an example navigation scheme employed by the user interface of FIG. 2.

FIG. 4 is a state diagram illustrating an example method of selecting an audio file.

### DESCRIPTION OF VARIOUS EMBODIMENTS

According to various embodiments, an entertainment system uses a user interface with existing head unit controls, such as radio preset controls and tuner controls, to select an audio file for playback. In particular, a user can access audio files using the preset controls to access associated metadata, such as artist, album, and genre information. In this way, the entertainment system may facilitate navigation and playback of a large number of audio files using an intuitive user interface. As a result, driver interaction with the user interface and the resulting potential for driver distraction may be reduced.

The following description of various embodiments implemented in a vehicle-based entertainment system is to be construed by way of illustration rather than limitation. This description is not intended to limit the invention or its applications or uses. For example, while various embodiments are described as being implemented in vehicle-based entertainment system, it will be appreciated that the principles of the invention are applicable to entertainment systems operable in other environments, such as home entertainment systems.

In the following description, numerous specific details are set forth in order to provide a thorough understanding of various embodiments. It will be apparent to one skilled in the art that some embodiments may be practiced without some or all of these specific details. In other instances, well known components and process steps have not been described in detail.

Various embodiments may be described in the general context of processor-executable instructions, such as program modules, being executed by a processor. Generally, program modules include routines, programs, objects, components, data structures, etc., that perform particular tasks or implement particular abstract data types. The invention may also be practiced in distributed processing environments in which tasks are performed by remote processing devices that are linked through a communications network or other data transmission medium. In a distributed processing environment, program modules and other data may be located in both local and remote storage media, including memory storage devices.

Referring now to the drawings, FIG. 1 is a block diagram illustrating an example vehicle entertainment system 100. A head unit 102 is mounted on a dashboard of the vehicle and includes a user interface subsystem 104 through which a driver or passenger can interact with the vehicle entertainment system 100. The user interface subsystem 104 includes a number of controls, such as, for example, a tuner knob 106, radio preset buttons 108, a volume knob 110, and an eject button 112 for ejecting a disk. While not shown in FIG. 1, the user interface subsystem 104 may include other controls, such as fade and balance controls, equalizer controls, etc. The user interface subsystem 104 also includes a display 114 for communicating information to the driver or passenger, such as the frequency of a radio station to which the vehicle entertainment system 100 is tuned or information relating to a compact disk (CD) that the vehicle entertainment system 100 is playing.

A media subsystem 116 is configured to read a storage medium, such as a CD, a CD-ROM, a Secure Digital (SD) memory card, or a MultiMedia Card (MMC). The media subsystem 116 receives the storage medium, for example, via a receptacle 118 formed in the head unit 102. Alternatively, data can be read from the storage medium via a wireless connection, including, but not limited to, a WiFi or Bluetooth communication link. The storage medium may store data, such as audio files in a variety of formats, including but not limited to the MP3, MP3Pro, WMA, AAC, and Ogg-Vorbis formats. These digitally compressed formats allow storage media, such as CDs, to store many more songs relative to uncompressed formats, such as the CD Audio format. For example, with a compression of 10:1, it is possible to store well over 100 songs on a single CD or thousands of songs on a hard disk drive (HDD), depending on disk capacity.

When a storage medium is inserted into the media subsystem 116, for example, through an opening 118 in the head unit 102, the media subsystem 116 reads data from the storage medium and communicates the data to a microprocessor 120, typically via a buffer (not shown). The data is then provided to one or more additional components, including, but not limited to, a digital signal processor (DSP) and a digital-to-analog converter (DAC), which convert the digital data signal to an analog signal. Speakers 122 then generate sound in response to the analog signal.

The microprocessor 120 is typically configured to operate with one or more types of processor readable media. Processor readable media can be any available media that can be accessed by the microprocessor 120 and includes both volatile and nonvolatile media, removable and non-removable media. By way of example, and not limitation, processor readable media may include storage media and communication media. Storage media includes both volatile and nonvolatile, removable and nonremovable media implemented in any method or technology for storage of information such as processor-readable instructions, data structures, program modules, or other data. Storage media includes, but is not limited to, RAM, ROM, EEPROM, flash memory or other memory technology, CD-ROM, digital versatile disks (DVDs) or other optical disk storage, magnetic cassettes, magnetic tape, magnetic disk storage or other magnetic storage devices, or any other medium that can be used to store the desired information and that can be accessed by the microprocessor 120. Communication media typically embodies processor-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above are also intended to be included within the scope of processor-readable media.

Certain storage media can store hundreds or thousands of audio files. Many conventional vehicle entertainment systems allow users to navigate audio files using a relatively limited set of navigation controls, such as “next track,” “previous track,” and “random track” controls. While such controls can be useful for navigating a small number of audio files, they are inadequate for navigating large numbers of audio files. For example, scanning for a song title in the middle of a list of 100 songs may take 50 “next song” button presses or many turns of a knob.

To facilitate navigating large numbers of audio files, the vehicle entertainment system 100 of FIG. 1 allows the user to filter audio files according to metadata encoded in the audio files. Filtering the audio files in this way reduces the number of files through which the user must navigate to arrive at the desired file. For example, the user can first filter a song list by the artist name. The user would then only need to scan through song titles associated with the selected artist name. In addition, the user can further shorten the list of song titles by also selecting the appropriate album name.

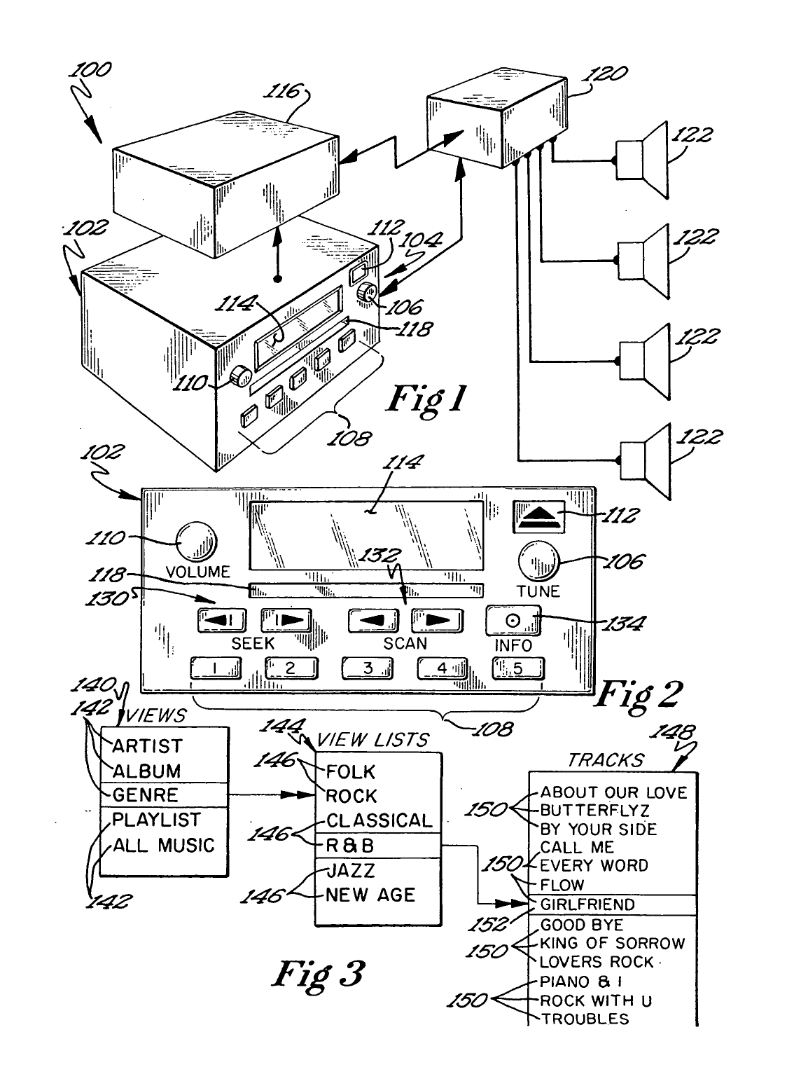

FIG. 2 illustrates an example implementation of the head unit 102 of FIG. 1. The head unit 102 includes a number of preset controls 108 and the tuner control 106. The tuner control may also serve as a selection control. As an alternative, the head unit 102 may incorporate a distinct selection control (not shown). The head unit 102 also incorporates the display 114, which preferably is able to display alphanumeric characters.

When a storage medium storing audio files with associated metadata is inserted in the opening 118, the media subsystem 116 reads the metadata associated with the audio files. The microprocessor 120 then generates a list of metadata fields, such as “Artist,” “Album,” “Genre,” “Playlist,” and “All Music,” based on the metadata. The microprocessor 120 also generates a list of filter criteria or entries within each metadata field. For example, within the metadata field “Artist,” the microprocessor 120 generates a list of artist names identified among the audio files.

The microprocessor 120 then commands the display 114 to present the user with a list of the metadata fields. The user can then select one of the metadata fields for further navigation using the preset controls 108. In particular, the preset controls 108 are associated with metadata fields or views. For example, pressing one preset control 108 might select the “Artist” metadata field, while pressing another might select the “Album” meta data field. Pressing yet another preset control 108 might allow the user to select from a number of playlists, while pressing still another preset control 108 might allow the user to view all audio files.

After the user selects a metadata field or view, the microprocessor 120 commands the display 114 to present the user with a listing of filter criteria related to the selected metadata field or view. For example, if the user selects the “Artist” metadata field, the display 114 would present the user with a list of artist names identified among the audio files. If the user selects the “Playlist” view, the display 114 would present the user with a list of playlists.

The user can then select one of the presented filter criteria, for example, using the tuner control 106. If the tuner control 106 is implemented as a knob, as shown in FIG. 2, the user can rotate the knob to scroll through the list of filter criteria. Alternatively, if the tuner control 106 is implemented as a rocker button or pair of buttons (not shown), the user can scroll through the list of filter criteria by pressing the button or buttons. As the user scrolls through the list of filter criteria, the filter criterion to which the user is currently navigated may be highlighted, for example, by an icon. When the desired filter criterion is highlighted, the user may select it by actuating the selection control. In one implementation, the user may actuate the selection control by pushing in the tuner control 106. Alternatively, the head unit 102 may incorporate an “Enter” button or other control (not shown) distinct from the tuner control 106.

When the user selects a filter criterion, the microprocessor 120 commands the display 114 to present the user with a listing of file identifiers, e.g., song titles, associated with the selected filter criterion. For example, when the user selects a particular artist name (filter criterion), the display 114 presents the user with a list of song titles for any audio files containing the selected artist name in their associated metadata.

The user then selects one of the audio files using a technique similar to the technique used for selecting the filter criterion. The user scrolls through the list of file identifiers using the tuner control 106. As the user scrolls through the list of file identifiers, the file identifier to which the user is currently navigated is highlighted. When the desired file identifier is highlighted, the user selects it by actuating the selection control, e.g., either by pushing in the tuner control 106 or by actuating a selection control distinct from the tuner control 106. The microprocessor 120 then commands the vehicle entertainment system 100 to output the audio file corresponding to the selected file identifier using the speakers 122.

In some embodiments, the head unit 102 may incorporate additional controls. For example, seek controls 130 can be used to navigate to the previous audio file or the next audio file in the current list of file identifiers. Scan controls 132 can be used to navigate to the previous entry or the next entry in the current list of metadata fields. For example, the user can actuate the scan controls 132 to navigate to different artist names. An information button 134 can be used to access information regarding the current audio file, such as the artist, album, or genre. The head unit 102 may incorporate further controls not shown in FIG. 2, including, but not limited to, “Repeat” and “Shuffle” controls to repeat or randomize the selected audio file, respectively.

FIG. 3 illustrates an example navigation scheme employed by the user interface of FIG. 2. When a storage medium storing audio files with associated metadata is inserted in the opening 118, the media subsystem 116 reads the metadata associated with the audio files. The display 114 then displays a list 140 of the metadata fields, or views, represented in the metadata. This list 140 is generated by the microprocessor 120 and may include entries 142 such as, for example, “Artist,” “Album,” “Genre,” “Playlist,” and “All Music,” based on the metadata.

When the user selects a particular metadata field or view by pressing a preset control 108, the display 114 displays a list of filter criteria or entries within the selected metadata field or view. For example, if the user selects the “Genre” metadata field as shown in FIG. 3, the display 114 displays a list 144 of available genres. The list 144 may include entries 146 such as, for example, “Folk,” “Rock,” “Classical,” “R & B,” “Jazz ,” and “New Age.”

The user can then scroll through the list 144 using the tuner control 106 and select a particular entry 146 either by pressing in the tuner control 106 or by actuating a distinct selection control. When the user selects an entry 146, the display 114 displays a list of file identifiers associated with the selected entry 146. For example, if the user selects the “R & B” genre as shown in FIG. 3, the display 114 displays a list 148 of file identifiers 150 associated with the “R & B” genre.

The user can navigate through the list 148 in a manner similar to that used for navigating through the list 144 of entries 146. For instance, actuating the tuner control 106 causes a selection bar 152 to highlight individual file identifiers 150. When the desired file identifier 150 is highlighted, the user can either press in the tuner control 106 or, alternatively, actuate a distinct selection control to select the highlighted file identifier 150. The vehicle entertainment system 100 then outputs the audio file corresponding to the selected file identifier 150 using the speakers 122.

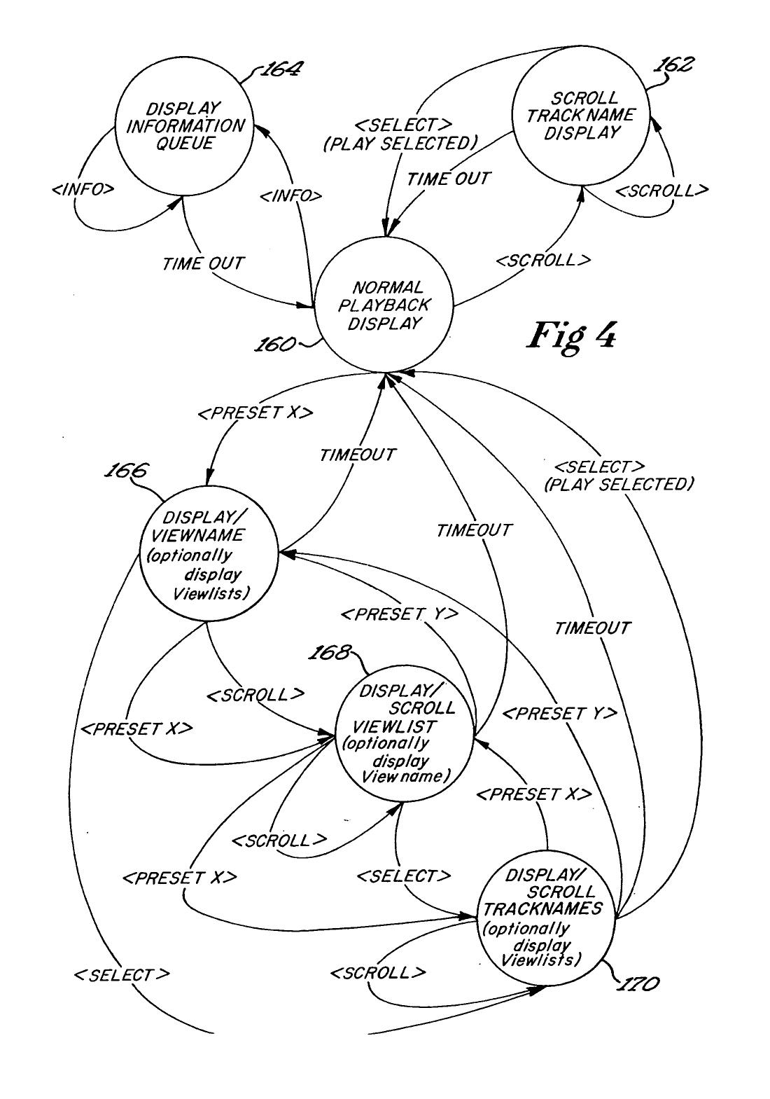

FIG. 4 is a state diagram illustrating an example method of selecting an audio file. As shown in FIG. 4, the display 114 can be placed in a number of display modes. In a normal playback display mode 160, the display 114 shows information, for example, regarding the audio file that is currently being played. This information may include the title of the audio file, the artist name, the genre, the temporal position within the audio file, and perhaps other information.

In the normal playback display mode 160, when the user actuates the tuner control 106, the display 114 enters a scroll track name display mode 162, in which the display 114 displays a listing of audio files in the current view. For example, if the user is currently viewing the audio files filtered by artist, the display 114 displays a listing of audio files corresponding to the currently selected artist. As another example, if the user is currently viewing the audio files in a playlist, the display 114 displays a listing of audio files in the playlist. The user can then view successive audio files in the listing by again actuating the tuner control 106 to scroll backward or forward through the listing. Pressing the tuner control 106 in or actuating a distinct selection control causes the vehicle entertainment system 100 to play the selected audio file, and the display 114 returns to the normal playback display mode 160. The display 114 also returns to the normal playback display mode 160, without changing the playback of the audio file, when a timeout condition occurs, i.e., if a predetermined period of time elapses without further action.

Again in the normal playback display mode 160, the user can cause the display 114 to enter a display information queue mode 164 by actuating the information button 134. In the display information queue mode 164, the display 114 presents various informational views, such as, for example, the song title, artist name, album title, and genre. Repeated presses of the information button 134 cycle between these informational views. The display 114 returns to the normal playback display mode 160 when a timeout condition occurs.

When one of the preset controls 108 is actuated when the display 114 is in the normal playback display mode 160, the display 114 enters a display view name mode 166, in which the display 114 shows the name of the metadata field or view corresponding to the actuated preset control 108. The display 114 returns to the normal playback display mode 160 upon a timeout condition.

In the display view name mode 166, actuating the tuner control 106 places the display 114 in a display/scroll viewlist mode 168 in which the user can scroll backward and forward through the list of metadata fields or views. In the display/scroll viewlist mode 168, the display 114 returns to the display view name mode 166 if one of the preset controls 108 is pressed. If a timeout condition occurs, the display 114 returns to the normal playback display mode 160.

Pressing the tuner control 106 in or actuating a distinct selection control when the display 114 is in either the display view name mode 166 or the display/scroll viewlist mode 168 selects a view and causes the display 114 to enter a display/scroll track names mode 170 in which the user may scroll backward and forward through the list of audio files within the selected view. The user can then press the tuner control 106 in or actuate a distinct selection control to select a particular audio file for playback, causing the display 114 to return to the normal playback display mode 160. In the display/scroll track names mode 170, the display 114 returns to the display view name mode 166 if one of the preset controls 108 is pressed. If a timeout condition occurs, the display 114 returns to the normal playback display mode 160.

As an alternative, pressing one of the preset controls 108 when the display 114 is in the normal playback display mode 160 may place the display 114 in the display/scroll viewlist mode 168 rather than the display view name mode 166. If the user interface is configured in this manner, pressing one of the preset controls 108 when the display 114 is in the display/scroll viewlist mode 168 causes the display 114 to enter the display view name mode 166. In this configuration, pressing one of the preset controls 108 when the display 114 is in the display view name mode 166 places the display 114 in the display/scroll track names mode 170. Pressing one of the preset controls 108 when the display 114 is in the display/scroll track names mode 170 causes the display 114 to return to the display view name mode 166.

As demonstrated by the foregoing discussion, various embodiments may provide certain advantages, particularly in the context of vehicle entertainment systems in which the potential for driver distraction should be reduced. The vehicle entertainment system incorporates an intuitive user interface that may facilitate navigation and playback of a large number of audio files. As a result, driver interaction with the user interface and the resulting potential for driver distraction may be reduced.

It will be understood by those who practice the invention and those skilled in the art that various modifications and improvements may be made to the invention without departing from the spirit and scope of the disclosed embodiments. The scope of protection afforded is to be determined solely by the claims and by the breadth of interpretation allowed by law.

What is claimed is:

1. A method to select an audio file that is associated with a plurality of metadata fields for output via an entertainment system having a plurality of preset controls, the method comprising:
associating a preset control with a metadata field;
in response to actuation of a preset control, presenting a set of filter criteria related to the metadata field associated with the actuated preset control;
receiving a user selection of one of the presented filter criteria;
presenting a set of file identifiers associated with the selected filter criterion; and
receiving a user selection of one of the file identifiers, the selected file identifier identifying an audio file for output via the entertainment system.

2. The method of claim 1, wherein the entertainment system has a tuner control, and wherein:
receiving the user selection of one of the presented filter criteria comprises receiving user input via the tuner control; and
receiving the user selection of one of the file identifiers comprises receiving user input via the tuner control.

3. The method of claim 2, wherein the tuner control comprises a knob.

4. The method of claim 2, wherein the tuner control comprises a button.

5. The method of claim 1, wherein the metadata fields comprises at least one of an artist name field, an album name field, and a genre field.

6. The method of claim 1, further comprising:
associating a preset control with a playlist selection function;
in response to actuation of the preset control associated with the playlist selection function, presenting a set of playlist identifiers;
receiving a user selection of one of the playlist identifiers;
presenting a set of file identifiers associated with the selected playlist identifier; and
receiving a user selection of one of the file identifiers, the selected file identifier identifying an audio file for output via the entertainment system.

7. The method of claim 1, further comprising:
associating a preset control with a comprehensive selection function;
in response to actuation of the preset control associated with the comprehensive selection function, presenting a set of file identifiers associated with a set of audio files available for output via the entertainment system; and
receiving a user selection of one of the file identifiers, the selected file identifier identifying a particular one of the audio files for output via the entertainment system.

8. A processor-readable medium having processor-executable instructions for:
associating a preset control of an entertainment system having a plurality of preset controls with a metadata field selected from a plurality of metadata fields associated with an audio file;
presenting a set of filter criteria related to a particular metadata field in response to actuation of a preset control associated with the particular metadata field;
presenting a set of file identifiers associated with a particular filter criterion in response to a user selection of the particular filter criterion; and
selecting for output via the entertainment system an audio file identified by a particular file identifier in response to a user selection of the particular file identifier.

9. The processor-readable medium of claim 8, wherein the entertainment system has a tuner control, and wherein the processor-readable medium further has processor-executable instructions for:
receiving the user selection of one of the presented filter criteria comprises receiving user input via the tuner control; and
receiving the user selection of one of the file identifiers comprises receiving user input via the tuner control.

10. The processor-readable medium of claim 8, wherein the metadata fields comprises at least one of an artist name field, an album name field, and a genre field.

11. The processor-readable medium of claim 8, further having processor-executable instructions for:
associating a preset control with a playlist selection function;
in response to actuation of the preset control associated with the playlist selection function, presenting a set of playlist identifiers;
receiving a user selection of one of the playlist identifiers;
presenting a set of file identifiers associated with the selected playlist identifier; and
receiving a user selection of one of the file identifiers, the selected file identifier identifying an audio file for output via the entertainment system.

12. The processor-readable medium of claim 8, further having processor-executable instructions for:
associating a preset control with a comprehensive selection function;
in response to actuation of the preset control associated with the comprehensive selection function, presenting a set of file identifiers associated with a set of audio files available for output via the entertainment system; and
receiving a user selection of one of the file identifiers, the selected file identifier identifying a particular one of the audio files for output via the entertainment system.

13. An entertainment system comprising:
a media subsystem configured to retrieve data from a data storage medium storing a plurality of audio files that are each associated with a plurality of metadata fields;
a user interface subsystem having a plurality of preset controls;
a microprocessor operatively coupled to the media subsystem and the user interface subsystem and configured to
associate a preset control with a metadata field,
in response to actuation of a preset control, command the user interface subsystem to display a set of filter criteria related to the metadata field associated with the actuated preset control,
receive a user selection of one of the presented filter criteria via the user interface subsystem,
command the user interface subsystem to display a set of file identifiers associated with the selected filter criterion, and
receive a user selection of one of the file identifiers via the user interface subsystem, the selected file identifier identifying a particular one of the plurality of audio files; and
a speaker arrangement operatively coupled to the microprocessor and configured to output the audio file identified by the selected file identifier.

14. The entertainment system of claim 13, wherein the user interface subsystem comprises a tuner control, and wherein the microprocessor is configured to:
receive the user selection of one of the presented filter criteria comprises receiving user input via the tuner control; and
receive the user selection of one of the file identifiers comprises receiving user input via the tuner control.

15. The entertainment system of claim 14, wherein the tuner control comprises a knob.

16. The entertainment system of claim 14, wherein the tuner control comprises a button.

17. The entertainment system of claim 13, wherein the metadata fields comprises at least one of an artist name field, an album name field, and a genre field.

18. The entertainment system of claim 13, wherein the microprocessor is configured to:
associate a preset control with a playlist selection function;
in response to actuation of the preset control associated with the playlist selection function, command the user interface subsystem to display a set of playlist identifiers;
receive a user selection of one of the playlist identifiers via the user interface subsystem;
command the user interface subsystem to display a set of file identifiers associated with the selected playlist identifier; and
receive a user selection of one of the file identifiers via the user interface subsystem, the selected file identifier identifying an audio file for output via the entertainment system.

19. The entertainment system of claim 13, wherein the microprocessor is configured to:
associate a preset control with a comprehensive selection function;
in response to actuation of the preset control associated with the comprehensive selection function, command the user interface subsystem to display a set of file identifiers associated with a set of audio files available for output via the entertainment system; and
receive a user selection of one of the file identifiers via the user interface subsystem, the selected file identifier identifying a particular one of the audio files for output via the entertainment system.

20. The entertainment system of claim 13, wherein the media subsystem is configured to receive data from at least one of a compact disk (CD), a CD-ROM, a memory module, a WiFi wireless communication link, and a Bluetooth communication link.
